(19) United States
(12) Patent Application Publication
(10) Pub. No.: US 2006/0050454 A1
(43) Pub. Date: Mar. 9, 2006

(54) Chip-on-chip type semiconductor device

(75) Inventors: Kazuhiro Koudate, Kanagawa (JP); Tomoaki Isozaki, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: NEC ELECTRONICS CORPORATION

(21) Appl. No.: 11/218,584

(22) Filed: Sep. 6, 2005

(30) Foreign Application Priority Data
Sep. 7, 2004 (JP) 259795/2004

(51) Int. Cl. H02H 9/00

(52) U.S. Cl. 361/56

(57) ABSTRACT

A chip-on-chip semiconductor device is composed of: a first chip operating on a first power supply voltage; and a second chip operating on a second power supply voltage lower than the first power supply voltage, the first and second chips being flip-chip connected through inter-chip connection bumps. The second chip is designed to provide level-conversion for a transmission signal received from the first chip.

### BACKGROUND OF THE INVENTION

1. Field of the Invention

The present invention relates to semiconductor devices adopting chip-on-chip packaging, more specifically, to chip-on-chip type semiconductor devices in which a plurality of semiconductor chips operated on different power supply voltages are integrated.

2. Description of the Related Art

The system-in-package technology (SiP) is one of the promising approaches for providing high-end semiconductor devices with reduced cost. Although the system-on-chip (SoC) technology is known as a technique almost similar to the SiP technology, the SiP technology is advantageous over the SoC technology in the development period and cost. Typical SiP technologies include the multi-chip packaging (MCP), in which a set of LSI chips stacked or arranged on a substrate are electrically connected through wires, and the chip-on-chip packaging (CoC), in which a pair of LSI chips are flip-chip connected.

The design optimization of inter-chip interface is important for SiP-based semiconductor devices. An inadequate inter-chip interface design may cause undesirable reduction of the signal transmission speed between or among LSI chips. As disclosed in Japanese Laid-Open Patent Application No. H05-267560, one proposed approach is to externally prepare a signal level converter chip; however, this approach undesirably increases the system cost.

More specifically, one problem in the design of inter-chip interface is that the SiP technology requires transmitting signals outside the LSI chips, that is, transmitting signals over wires having an increased capacitance between the LSI chips. Another problem is that the LSI chips may be operated on different power supply levels.

A commonly-used approach for resolving the former problem is to use output buffers with large drive ability for inter-chip interface, more specifically, to achieve inter-chip interface by using output buffers designed identically to the I/O buffers used for external signal output.

The latter problem is commonly resolved by reducing a signal level of a transmission signal from a first LSI chip operating on a higher power supply voltage to a second LSI chip operating on a lower power supply voltage, down to a signal level allowable for the second LSI chip.

The inventors have discovered that the above-described approach unnecessarily decreases the signal transmission speed, and undesirably increases the chip size. For signal transmission from a first LSI chip operating on a higher power supply voltage to a second LSI chip operating on a lower power supply voltage, reducing the signal level of a transmission signal transmitted from the first LSI chip to the second LSI chip undesirably decreases the signal transmission speed due to the increased signal skew of the transmission signal; it should be noted that operating a transistor on a voltage lower than the rated power supply voltage causes undesirable output signal skew, because transistors are optimized to operate on the rated power supply voltage. When a MOS transistor designed to operate on a power supply voltage of 2V is operated on a power supply voltage of 1V, for example, the MOS transistor suffers from undesirable output signal skew due to the lack of the drive ability. This necessitates using a high drive buffer for reducing the output signal skew, resulting in the undesirable increase in the LSI chip size.

Therefore, there is a need for providing a technique for avoiding the reduction in the transmission speed of signals transmitted between LSI chips operating on different power supply voltages, with reduced LSI chip size.

### SUMMARY OF THE INVENTION

In an aspect of the present invention, a chip-on-chip semiconductor device is composed of: a first chip operating on a first power supply voltage; and a second chip operating on a second power supply voltage lower than the first power supply voltage, the first and second chips being flip-chip connected through inter-chip connection bumps. The second chip is designed to provide level-conversion for a signal received from the first chip.

Such architecture allows the first chip to develop the transmission signal to have a signal level equal to the first power supply voltage, on which the first chip operates. This avoids unnecessary decrease in the transmission speed of the transmission signal. Additionally, this architecture effectively reduces the chip size of the first chip, because MOS transistors optimized for the first power supply voltage can be used for developing the transmission signal within the first chip.

### BRIEF DESCRIPTION OF THE DRAWINGS

The above and other advantages and features of the present invention will be more apparent from the following description taken in conjunction with the accompanied drawings, in which:

FIG. 1 is a section view illustrating a section structure of a semiconductor device in one embodiment of the present invention;

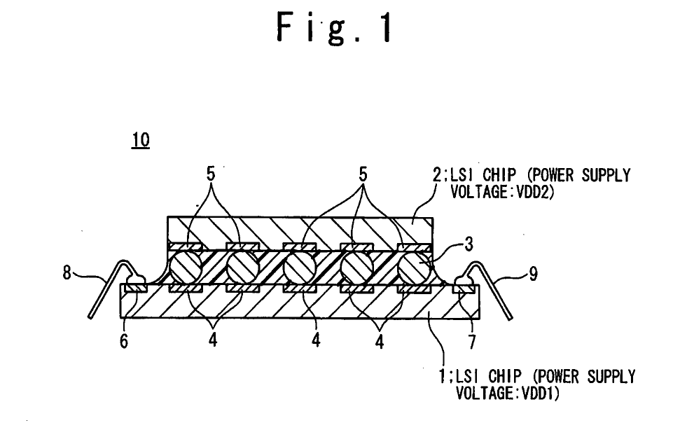

FIG. 2 is a block diagram illustrating an exemplary circuit arrangement of the semiconductor device in this embodiment;

FIG. 3 is a circuit diagram illustrating an exemplary structure of an I/O buffer integrated within the semiconductor device in this embodiment;

FIG. 4 is a circuit diagram illustrating an exemplary structure of another I/O buffer integrated within the semiconductor device in this embodiment;

FIG. 5 is a circuit diagram illustrating an exemplary structure of an output buffer integrated within the semiconductor device in this embodiment;

FIG. 6 is a circuit diagram illustrating an exemplary structure of another output buffer integrated within the semiconductor device in this embodiment;

FIG. 7 is a circuit diagram illustrating an exemplary structure of a signal level converter circuit integrated within the semiconductor device in this embodiment; and

FIG. 8 is a circuit diagram illustrating an exemplary structure of another signal level converter circuit integrated within the semiconductor device in this embodiment.

### DESCRIPTION OF THE PREFERRED EMBODIMENTS

The invention will be now described herein with reference to illustrative embodiments. Those skilled in the art would recognize that many alternative embodiments can be accomplished using the teachings of the present invention and that the invention is not limited to the embodiments illustrated for explanatory purposed.

(Semiconductor Device Structure)

In one embodiment of the present invention, a chip-on-chip type semiconductor device 10 is composed of a pair of LSI chips 1 and 2 that are flip-chip connected via inter-chip connection bumps 3. The LSI chip 1 is provided with pads 4 for signal interface with the LSI chip 2, and the LSI chip 2 is provided with pads 5 for signal interface with the LSI chip 1. The inter-chip connection bumps 3 provides mechanical connections between the LSI chips 1 and 2, and also provides electrical connections between the pads 4 and 5 on the LSI chips 1 and 2.

The LSI chip 1 is additionally provided with external connection pads 6 and 7. The external connection pads 6 and 7 are connected with wires 8 and 9, respectively. The wires 8 and 9 are used for external signal input/output of the semiconductor device 10.

The LSI chip 1 and 2 operates on different power supply voltages; the power supply voltage VDD2 of the LSI chip 2 is higher than the power supply voltage VDD1 of the LSI chip 1. As described above, the difference in the power supply voltages between the LSI chips 1 and 2 necessitates design optimization of the signal interfacing therebetween. The architecture of the semiconductor device 10 in this embodiment addresses the optimization of the signal interfacing between the LSI chips 1 and 2.

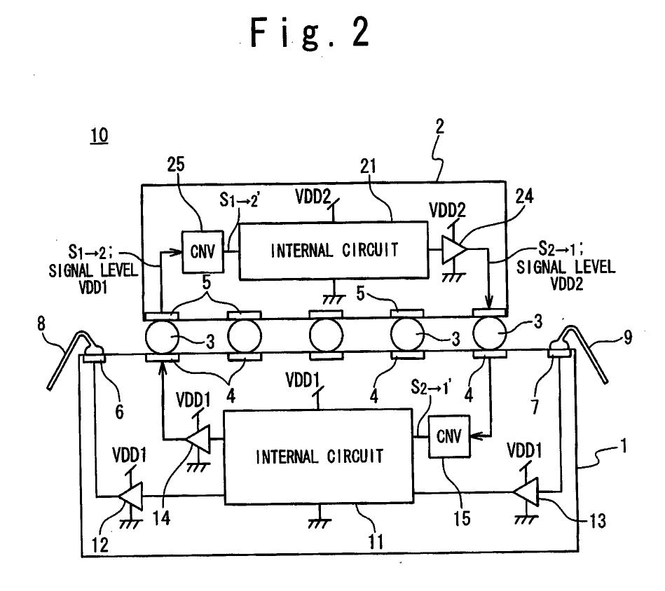

FIG. 2 is a circuit diagram illustrating exemplary circuit arrangements of the LSI chips 1 and 2. The LSI chip 1 is composed of an internal circuit 11, I/O buffers 12 and 13, an output buffer 14, and a signal level converter circuit 15. The LSI chip 2 is composed of an internal circuit 21, an output buffer 24, and a signal level converter circuit 25.

The internal circuits 11 and 21 provide main functions of the LSI chips 1 and 2. The internal circuits 11 and 21 operates on different power supply voltages: the internal circuit 11 within the LSI chip 1 operates on the power supply voltage VDD1, and the internal circuit 21 within the LSI chip 2 operates on the power supply voltage VDD2, higher than the power supply voltage VDD1. Due to the difference in the power supply voltage, MOS transistors within the internal circuits 11 and 21 are manufactured through different processes. The MOS transistors within the internal circuit 11 are designed to be optimized for the power supply voltage VDD1, and the MOS transistors within the internal circuit 12 are designed to be optimized for the power supply voltage VDD2. More specifically, gate dielectrics of the MOS transistors within the internal circuit 11 have a thickness smaller than that of gate dielectrics of the MOS transistors within the internal circuit 21.

The I/O buffer 12 is used for externally outputting an external output signal to an external device. The I/O buffer 12 has an input connected to the internal circuit 11, and an output connected to the external connection pad 6. The I/O buffer 12 externally outputs the external output signal to an external device in response to a signal received from the internal circuit 11. The I/O buffer 12 is composed of large-sized MOS transistors, that is, MOS transistors with large gate widths, for allowing the I/O buffer 12 to output the external output signal with reduced signal skew through the wire 8, which has an increased capacitance.

The output of the I/O buffer 12 is connected with a relatively large-sized ESD (electrostatic discharge) protection element, since the external connection pad 6 may be subjected to a relatively large surge. The ESD protection element may include an off-transistor, that is, a PMOS or NMOS transistor having a drain connected with a source thereof. Instead, the ESD protection element may be composed of an ESD protection diode. The use of a large-size ESD element is important for avoiding the LSI chip 1 being destroyed by a surge applied to the external connection pad 6.

The I/O buffer 13 is used for transferring an external signal received from an external device to the internal circuit 11. The I/O buffer 13 has an input connected with the external pad 7, and an output connected with the internal circuit 11, outputting a signal equivalent to the external signal received to the internal circuit 11. As is the case of the I/O buffer 12, the I/O buffer 13 is composed of relatively large-sized MOS transistors. This is because the distance from the I/O buffer 13 to the internal circuit 11 is inevitably increased due to the layout requirement, and an interconnection between the output of the I/O buffer 13 and the internal circuit 11 has an increased capacitance.

As is the case of I/O buffer 12, the output of the I/O buffer 13 is connected with a relatively large-sized ESD protection element. The use of a large-size ESD element is important for avoiding the LSI chip 1 being destroyed by a surge applied to the external connection pad 7.

The signal interface between the LSI chip 1 and 2 is achieved by the output buffer 14 and the signal level converter circuit 15 within the LSI chip 1, and the output buffer 24 and the signal level converter circuit 25 within the LSI chip 2. A signal transmitted from the LSI chip 1 to the LSI chip 2 is referred to as a transmission signal S_{1→2}, and a signal transmitted from the LSI chip 2 to the LSI chip 1 is referred to as a transmission signal S_{2→1}, hereinafter.

The MOS transistors within the output buffer 14 are formed concurrently to the MOS transistors within the internal circuit 11 during the manufacture process of the LSI chip 1. Correspondingly, the MOS transistors within the output buffer 24 are formed concurrently to the MOS transistors within the internal circuit 21 during the manufacture process of the LSI chip 2. In other words, the MOS transistors within the output buffer 14 is designed to be optimized for the power supply voltage VDD1, and the MOS transistors within the output buffer 24 is designed to be optimized for the power supply voltage VDD2.

The transmission signals S_{1→2} and S_{2→1} are developed so that the signal levels thereof are identical to the power supply voltages of the transmitting sides. The transmission signals are level-converted into the input signal levels of the internal circuits of the receiving sides. More specifically, the output buffer 24 within the LSI chip 2 is provided with the power supply voltage VDD2, and outputs the transmission signal S_{2→1} having the signal level identical to the power supply voltage VDD2 to the LSI chip 1. The signal level converter circuit 15 within the LSI chip 1 provides level-conversion for the transmission signal S_{2→1} to develop a reception signal S_{2→1}′ having a signal level identical to the power supply voltage VDD1. The reception signal S_{2→1}′ is inputted to the internal circuit 11. Correspondingly, the output buffer 14 within the LSI chip 1 is provided with the power supply voltage VDD1, and outputs the transmission signal S_{1→2} having the signal level identical to the power supply voltage VDD1 to the LSI chip 2. The signal level converter circuit 25 within the LSI chip 2 provides level-conversion for the transmission signal S_{1→2} to develop a reception signal S_{1→2}′ having a signal level identical to the power supply voltage VDD1. The reception signal S_{1→2}′ is inputted to the internal circuit 21.

This architecture allows the size reduction of the output buffers 14 and 24, while avoiding the decrease in the transmission speed of the transmission signals S_{1→2} and S_{2→1}, which are exchanged between the LSI chips 1 and 2. For the output buffer 24 within the LSI chip 2, for example, the above-described architecture operates the output buffer 24 on an operating voltage identical to the power supply voltage VDD2 (>VDD1), not the power supply voltage VDD1. Therefore, the output buffer 24 makes full use of the drive ability thereof; operating the output buffer 24 on an operating voltage identical to the power supply voltage VDD1 would inhibit the output buffer 24 from making full use of the drive ability. Since the output buffer 24 makes full use of the drive ability thereof, the MOS transistors within the output buffer 24 are allowed to be similar in size to the MOS transistors within the internal circuit 21, eliminating a need for forming the output buffer 24 with large sized MOS transistors for establishing high-speed transmission, on the contrary of the I/O buffer 12. The semiconductor device 10 in this embodiment do not require the MOS transistors within the output buffer 24 to have increased sizes under the conditions that the output buffer 24 is designed to allow the MOS transistors integrated therein to make full use of the drive abilities thereof, because the COC architecture of the semiconductor device 10 reduces the parasitic capacitances of the inter-chip connection bumps 3, the pads 4 and 5, which function as the interface of the transmission signal S_{1→2}.

The same applies to the output buffer 14 within the LSI chip 1. The aforementioned architecture operates the output buffer 14, which is optimized for the power supply voltage VDD1, on an operating voltage identical to the power supply voltage VDD1. This allows the output buffer 14 to make full use of the drive ability thereof, eliminating the need for forming the output buffer 14 with large-sized MOS transistors.

ESD protection elements may be connected with the outputs of the output buffers 14 and 24 (that is, the pads 4 and 5 connected with the output buffers 14 and 24). In this case, the size of the ESD protection elements connected with the output buffers 14 and 24 is preferably reduced below the size of the ESD protection elements connected with the I/O buffer 12. This effectively reduces the chip sizes of the LSI chips 1 and 2. It should be noted that the reduction in the size of the ESD protection elements connected with the output buffers 14 and 24 does not cause a serious ESD problem. Although receiving relatively small charge during the manufacturing process including the flip-chip connection for forming the COC structure, the outputs of the output buffers 14 and 24 do not receive large surge from the external world. The reduction in the size of the ESD protection elements is also effective for avoiding the undesirable decrease in the transmission speed of the transmission signals S_{1→2} and S_{2→1}. The reduction in the size of the ESD protection elements effectively reduces the load capacitances of the output buffers 14 and 24 to improve the transmission speed of the transmission signals S_{1→2} and S_{2→1}.

Additionally, ESD protection elements may be connected with the inputs of the signal level converter circuits 15 and 25 (that is, the pads 4 and 5 connected with the signal level converter circuits 15 and 25). In this case, the size of the ESD protection elements connected with the signal level converter circuits 15 and 25 is preferably reduced below the size of the ESD protection elements connected with the I/O buffer 13. The reduction in the size of the ESD protection elements connected with the signal level converter circuits 15 and 25 does not cause any ESD problem. Rather, the reduction in the size of the ESD protection elements reduces the chip sizes of the LSI chips 1 and 2, and improves the transmission speed of the transmission signals S_{1→2} and S_{2→1}.

A detailed description is made of exemplary structures of the I/O buffers 12 and 13, the output buffers 14 and 24, and the signal level converter circuits 15 and 25, which achieves the aforementioned architecture.

(I/O Buffer Structure)

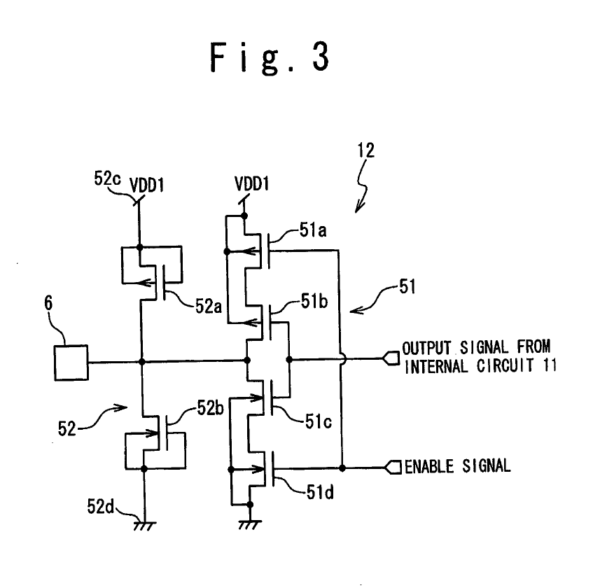

FIG. 3 is a circuit diagram illustrating an exemplary structure of the I/O buffer 12, which is used for an external output signal. In this embodiment, the I/O buffer 12 adopts a widely-known I/O buffer structure. Specifically, the I/O buffer 12 is composed of an inverter 51 and an ESD protection circuit 52. The inverter 51 has an input connected with the internal circuit 11, an output connected with the external connection pad 6, and an enable terminal. The inverter 51 is composed of four MOS transistors: PMOS transistors 51a and 51b, and NMOS transistors 51c and 51d. The ESD protection circuit 52 is composed of a pair of ESD protection elements 52a and 52b. The ESD protection element 52a is connected between the external connection pad 6 and a power supply terminal 52c, and the ESD protection element 52a is connected between the external connection pad 6 and an earth terminal 52d. A PMOS transistor having the gate connected with the drain thereof is used as the ESD protection element 52a, and an NMOS transistor having the gate connected with the drain thereof is used as the ESD protection element 52b.

In order to externally output the external output signal through the wire 8, which has an increased capacitance, the PMOS transistors 51a and 51b, and the NMOS transistors 51c and 51d are large-sized, having large gate widths. In one embodiment, the gate widths of the PMOS transistors 51a and 51b, and the NMOS transistors 51c and 51d are several-tens micrometers.

Relatively large-sized MOS transistors are used as the ESD protection elements 52a and 52b, because the wire 8 may be subjected to a relatively increased surge. The use of the large-sized ESD protection elements 52a and 52b is important for avoiding the destruction of the LSI chip 1 caused by the surge applied on the wire 8.

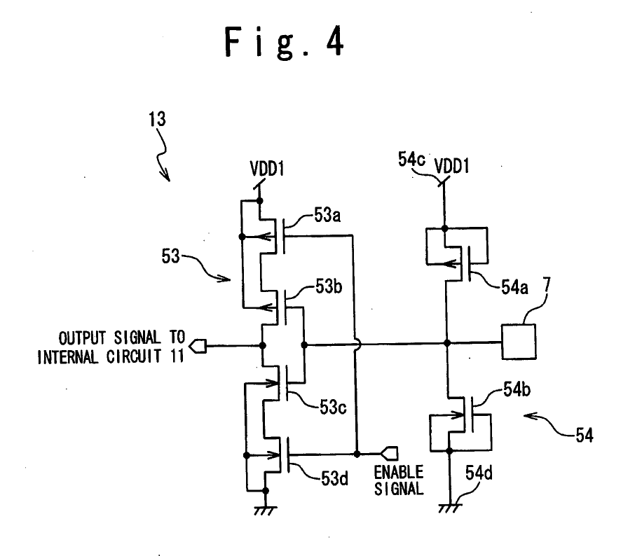

FIG. 4 is a circuit diagram illustrating the I/O buffer 13, which is used for transferring the external signal to the internal circuit 11. The I/O buffer 13 also adopts the widely-known I/O buffer structure described above. The I/O buffer 13 is composed of an inverter 53 and an ESD protection circuit 54. The inverter 53 has an input connected with the external connection pad 7, an output connected with the internal circuit 11, and an enable terminal. The inverter 53 is composed of four MOS transistors: PMOS transistors 53a and 53b, and NMOS transistors 53c and 53d. The ESD protection circuit 54 is composed of a pair of ESD protection elements 54a and 54b. The ESD protection element 54a is connected between the external connection pad 7 and a power supply terminal 54c, and the ESD protection element 54a is connected between the external connection pad 7 and an earth terminal 54d. A PMOS transistor having the gate connected with the drain thereof is used as the ESD protection element 54a, and an NMOS transistor having the gate connected with the drain thereof is used as the ESD protection element 54b.

As is the case of the I/O buffer 12, the PMOS transistors 53a and 53b, and the NMOS transistors 53c and 53d within the I/O buffer 13 are large-sized, having large gate widths. This is because the distance from the I/O buffer 13 to the internal circuit 11 is inevitably large due to the layout requirement, and therefore the interconnection connected with the output of the inverter 53 inevitably has an increased capacitance.

Additionally, relatively large-sized MOS transistors are used as the ESD protection elements 54a and 54b, because the wire 9 may be subjected to a relatively increased surge.

(Output Buffer Structure)

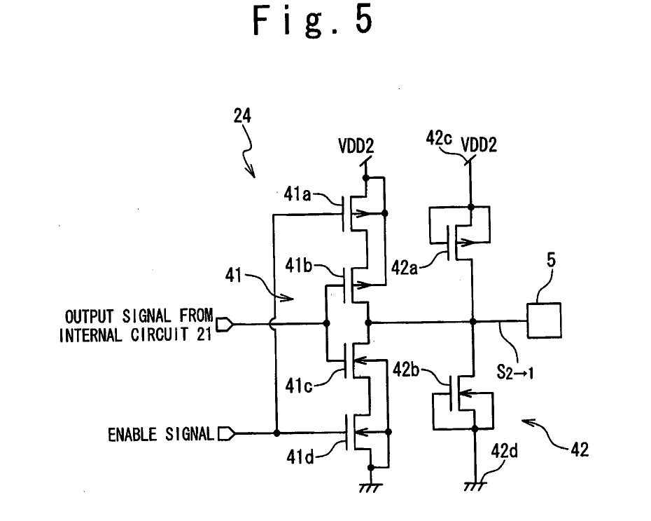

FIG. 5 is a circuit diagram illustrating an exemplary structure of the output buffer 24 within the LSI chip 2. In this embodiment, the circuit topology of the output buffer 24 is identical to that of the I/O buffer 12 shown in FIG. 3. In detail, the output buffer 24 is composed of an inverter 41 having an enable terminal, and an ESD protection circuit 42. The inverter 41 is composed of PMOS transistors 41a and 41b, and NMOS transistors 41c and 41d. The ESD protection circuit 42 is composed of an ESD protection element 42a connected between the pad 5 and a power supply terminal 42c, and an ESD protection element 42b connected between the pad 5 and an earth terminal 42d. The transmission signal S_{2→1} is transmitted from the output of the inverter 41 (that is, the pad 5) to the LSI chip 1.

One difference between the output buffer 24 and the I/O buffer 12 exists in the sizes of the MOS transistors integrated therein. The sizes of the PMOS transistors 41a and 41b and the NMOS transistors 41c and 41d within the output buffer 24 are different from those of the PMOS transistors 51a and 51b and the NMOS transistors 51c and 51d within the I/O buffer 12. In detail, the gate widths of the PMOS transistors 41a and 41b and the NMOS transistors 41c and 41d within the output buffer 24 are larger than those of the PMOS transistors 51a and 51b and the NMOS transistors 51c and 51d within the I/O buffer 12. As described above, the relatively reduced sizes of the PMOS transistors 41a and 41b and the NMOS transistors 41c and 41d do not cause serious decrease in the transmission speed of the transmission signal S_{2→1}. Rather, reducing the sizes of the PMOS transistors 41a and 41b and the NMOS transistors 41c and 41d effectively reduces the chip size of the LSI chip 2.

Another difference exists in the sizes of the ESD protection elements; the sizes of the ESD protection elements 42a and 42b within the output buffer 24 are smaller than those of the ESD protection elements 52a and 52b within the I/O buffer 12. The use of size-reduced ESD protection elements is effectively for reducing the chip size of the LSI chip 2. The reduction in the sizes of the ESD protection elements 42a and 42b do not cause a serious ESD problem, because the output of the output buffer 24 is free from a large surge externally applied from the external world.

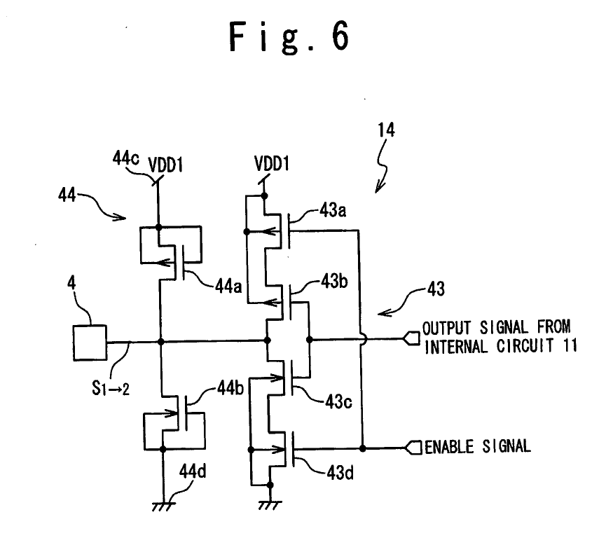

The same applies to the output buffer 14 within the LSD chip 1. As shown in FIG. 6, the circuit topology of the output buffer 14 is identical to that of the I/O buffer 12 shown in FIG. 3. The output buffer 14 is composed of an inverter 43 having an enable terminal and an ESD protection circuit 44. The inverter 43 is composed of PMOS transistors 43a and 43b and NMOS transistors 43c and 43d. The ESD protection circuit 44 is composed of an ESD protection element 44a connected between the pad 4 and a power supply terminal 44c, and an ESD protection element 44b connected between the pad 4 and an earth terminal 44b. The transmission signal S_{1→2} is transmitted from the output of the inverter 43 to the LSI chip 2.

The sizes of the PMOS transistors 43a and 43b and the NMOS transistors 43c and 43d within the output buffer 14 are smaller than those of the PMOS transistors 51a and 51b and the NMOS transistors 51c and 51d within the I/O buffer 12. The relatively-reduced sizes of the PMOS transistors 43a and 43b and the NMOS transistors 43c and 43d do not cause a serious problem in the transmission speed of the transmission signal S_{1→2}; rather effectively achieves the chip size reduction. Additionally, the sizes of the ESD protection elements 44a and 44b within the output buffer 14 are smaller than those of the ESD protection elements 52a and 52b within the I/O buffer 12. The use of size-reduced ESD protection elements is effectively for reducing the chip size of the LSI chip 2, while not causing a serious ESD problem.

(Structure of Signal Level Converter Circuit)

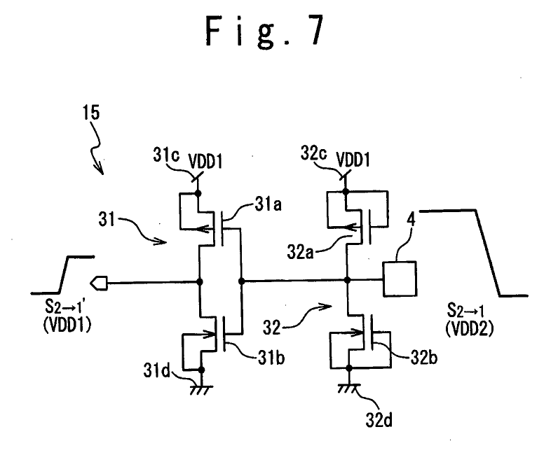

FIG. 7 is a circuit diagram illustrating an exemplary structure of the signal level converter 15 within the LSI chip 1. The signal level converter 15 is composed of an inverter 31 and an ESD protection circuit 32.

The inverter 31 is composed of PMOS and NMOS transistors 31a and 31b connected in series between a power supply terminal 31c and an earth terminal 31d. The PMOS and NMOS transistors 31a and 31b have commonly-connected gates, and commonly-connected drains. The commonly-connected gates of the PMOS and NMOS transistors 31a and 31b receives the transmission signal S_{2→1} from the LSI chip 2, and the reception signal S_{2→1}′ is developed on the commonly-connected drains of the PMOS and NMOS transistors 31a and 31b, and supplied to the internal circuit 11. The logical value of the reception signal S_{2→1}′ is complementary to that of the transmission signal S_{2→1}.

The PMOS and NMOS transistors 31c incorporates gate dielectrics having a thickness larger than that of the gate dielectrics of the MOS transistors within the internal circuit 11, which operates on the power supply voltage VDD1. This is because the gates of the PMOS and NMOS transistors 31a and 31b receives a voltage higher than the power supply voltage VDD1, provided for the internal circuit 11. The use of MOS transistors incorporating thickness-increased gate dielectrics is important for the protection of the signal level converter circuit 15.

The signal level of the reception signal S_{2→1}′ is identical to the power supply voltage VDD1, since the power supply terminal 31c of the inverter 31 is supplied with the power supply voltage VDD1. In other words, the signal level converter circuit 15 provides a function of converting the transmission signal S_{2→1}, having a signal level equal to the power supply voltage VDD2, into the reception signal S_{2→1}′, having a signal level equal to the power supply voltage VDD1.

The ESD protection circuit 32 is composed of an ESD protection element 32a connected between the pad 5 and a power supply terminal 32c, and an ESC protection element 32b connected between the pad 5 and an earth terminal 32d. In this embodiment, the ESD protection element 32a is composed of a PMOS transistor having the gate connected with the drain thereof, and the ESD protection element 32b is composed of an NMOS transistor having the gate connected with the drain thereof.

The sizes of the ESD protection elements 32a and 32b within the signal level converter circuit 15 are smaller than those of the ESD protection elements 54a and 54b within the I/O buffer 13. This effectively reduces the chip size of the LSI chip 1. The reduction in the sizes of the ESD protection elements 32a and 32b does not cause a serious ESD problem, because the input of the signal level converter circuit 15 is free from a surge externally applied from the external world. Rather, the ESD protection elements 32a and 32b is effective for improving the transmission speed of the transmission signal S_{2→1}.

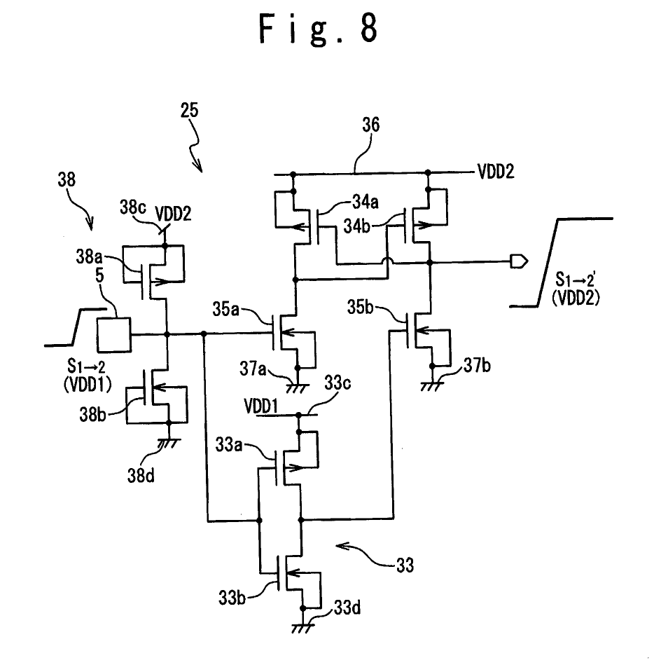

FIG. 8 is a circuit diagram illustrating an exemplary structure of the signal level converter circuit 25. The signal level converter circuit 25 is composed of an inverter 33, PMOS transistors 34a, 34b, and NMOS transistors 35a, and 35b.

The inverter 33 is composed of PMOS and NMOS transistors 33a and 33b connected in series between a power supply terminal 33c and an earth terminal 33d. The power supply terminal 33c is provided with the power supply voltage VDD1, not the power supply voltage VDD2 on which the internal circuit 21 within the LSI chip 2 operates. The signal level of the output signal of the inverter 33 is equal to the power supply voltage VDD1, since the power supply terminal 33c receives the power supply voltage VDD1. The power supply voltage VDD1 provided with the power supply terminal 33c may be generated by a step-down power supply within the LSD chip 2, or provided from the LSI chip 1 through one of the inter-chip connection bumps 3. The gate dielectrics of the PMOS and NMOS transistors 33a and 33b have a thickness equal to that of the gate dielectrics of the MOS transistors within the internal circuit 21 of the LSD chip 2. Although the output signal of the inverter 33 may be skewed due to the fact that the MOS transistors 33a and 33b, optimized for the power supply voltage VDD2, are operated on the power supply voltage VDD1, the delay within the signal level converter circuit 25 is not significant because the output signal of the inverter 33 is directly inputted into the gate of the NMOS transistor 35b, eliminating the need for driving a large-capacitance interconnection, such as bumps.

Those skilled in the art would appreciate that the inverter 33, the PMOS transistors 34a, 34b, and the NMOS transistors 35a and 35b constitute a level shifter of a commonly known structure. The PMOS and NMOS transistors 34a and 35a are connected in series between a power supply terminal 36 and an earth terminal 37a, and the PMOS and NMOS transistors 34b and 35b are connected in series between the power supply terminal 36 and an earth terminal 37b. The power supply terminal 36 is provided with the power supply voltage VDD2 of the LSI chip 2. The drains of the PMOS and NMOS transistors 34a and 35a are connected with the gate of the PMOS transistor 34b, and the drains of the PMOS and NMOS transistors 34b and 35b are connected with the gate of the PMOS transistor 34a. The drains of the PMOS and NMOS transistors 34b and 35b function as an output terminal on which the reception signal S_{1→2}′ is developed by the signal conversion circuit 25. The gate of the NMOS transistor 35a is supplied with the transmission signal S_{1→2}, and the gate of the NMOS transistor 35b is supplied with the transmission signal S_{1→2} through the inverter 33.

The gate dielectrics of the PMOS transistors 34a, 34b, and the NMOS transistors 35a and 35b have a thickness larger than that of the gate dielectrics of the MOS transistors within the internal circuit 21, operating on the power supply voltage VDD2. This is because the gates of the PMOS transistors 34a, 34b, and the NMOS transistors 35a and 35b receives the power supply voltage VDD1, which is lower than the power supply voltage VDD2 of the internal circuit 21. The use of the MOS transistors incorporating gate dielectrics having an increased thickness is important for protecting the MOS transistors 34a, 34b, 35a, and 35b.

The signal level of the reception signal S_{1→2}′ developed by the signal level converter circuit 25 is equal to the power supply voltage VDD2, because the power supply terminal 36 is supplied with the power supply voltage VDD2. In other words, the signal level converter circuit 25 provides a function of converting the transmission signal S_{1→2} having a signal level equal to the power supply voltage VDD1 into the reception signal S_{1→2}′ having a signal level equal to the power supply voltage VDD2.

The signal level conversion circuit 25 additionally includes an ESD protection circuit 38 connected with the pad 5. The ESD protection circuit 38 is composed of an ESD protection element 38a connected between the pad 5 and a power supply terminal 38c, and an ESD protection circuit 38b connected between the pad 5 and an earth terminal 38d. In this embodiment, the ESD protection element 38a is composed of a PMOS transistor having the gate connected with the drain, and the ESD protection element 38b is composed of an NMOS transistor having the gate connected with the drain.

As is the case of the signal level conversion circuit 15, the sizes of the ESD protection elements 38a and 38b within the signal level conversion circuit 25 are smaller than those of the ESD protection elements 54a and 54b within the I/O buffer 13. This effectively reduces the chip size of the LSD chip 2. As described above, the reduction in the size of the ESD protection elements 38a and 38b does not cause a serious ESD problem, because the input of the signal level conversion circuit 25 is free from a surge externally applied from the external worlds. Rather, the reduction of the ESD protection elements 38a and 38b is effective for improving the transmission speed of the transmission signal S_{1→2}.

### CONCLUSION

As thus described, the COC-type semiconductor device 10 is designed so that the signal levels of the transmission signals S_{1→2} and S_{2→1}, exchanged between the LSI chips 1 and 2, are equal to the power supply voltages of the transmitting size. The transmission signals are level-converted by the signal level converter circuits within the receiving sides into the signal levels to which the internal circuits of the receiving sides are adapted. Such architecture allows the use of the size-reduced output buffers 14 and 24, avoiding the decrease in the transmission speed of the transmission signals S_{1→2} and S_{2→1}. More specifically, the above-described architecture allows the MOS transistors within the output buffers 14 and 24 to have a size smaller than that of the MOS transistors within the I/O buffer 12, which develops the external output signal.

Additionally, the architecture described in this embodiment allows the ESD protection elements 42a, 42b, 44a, and 44b within the output buffers 14 and 24 to have a size smaller than that of the ESD protection element 52a and 52b within the I/O buffer 12. This effectively achieves the chip size reduction, and also improves the transmission speed of the transmission signals S_{1→2} and S_{2→1}.

It is apparent that the present invention is not limited to the above-described embodiments, which may be modified and changed without departing from the scope of the invention. It should be especially noted that the ESD protection elements may be composed of a protection diode in place of off-transistors, that is, PMOS or NMOS transistors having the gate connected with the drain thereof. It should be noted that the size of the ESD protection elements refers to the gate width of the off-transistors for the ESD protection circuits based on the MOS transistor-based, and refers to the size of the PN junction within the protection diode for the ESD protection circuit based on the protection diodes.

What is claimed is:

1. A chip-on-chip semiconductor device comprising:
a first chip operating on a first power supply voltage;
a second chip operating on a second power supply voltage lower than said first power supply voltage, said first and second chips being flip-chip connected through inter-chip connection bumps,
wherein said second chip is designed to provide level-conversion for a signal received from said first chip.

2. The chip-on-chip semiconductor device according to claim 1, wherein one of said first and second chips includes:
an external output buffer externally outputting an external output signal to an external device; and
an output buffer outputting a transmission signal to another of said first and second chips, and
wherein sizes of MOS transistors within said output buffer are larger than those of MOS transistors within said external output buffer.

3. The chip-on-chip semiconductor device according to claim 2, wherein gate widths of said MOS transistors within said output buffers are smaller than those of said MOS transistors within said external output buffer.

4. The chip-on-chip semiconductor device according to claim 2, wherein said output buffer includes a first ESD protection element,
wherein said external output buffer includes a second ESD protection element, and
wherein said first ESD protection element has a size smaller than that of the second ESD protection element.

5. The chip-on-chip semiconductor device according to claim 2, wherein said first chip is designed to develop a first transmission signal having a signal level equal to said first power supply voltage, and
wherein said second chip is designed to develop a second transmission signal having a signal level equal to said second power supply voltage.

6. The chip-on-chip semiconductor device according to claim 5, wherein said first chip includes a first signal level conversion circuit converting said second transmission signal to a first reception signal having a signal level equal to the first power supply voltage, and
wherein said second chip includes a second signal level conversion circuit converting said first transmission signal to a second reception signal having a signal level equal to the second power supply voltage.
